(19) United States
(12) Patent Application Publication
(10) Pub. No.: US 2024/0377858 A1
(43) Pub. Date: Nov. 14, 2024

(54) GLASS MEMBER, INPUT DEVICE, PEN INPUT DEVICE, MOBILE APPARATUS, AND METHOD FOR MANUFACTURING GLASS MEMBER

(71) Applicant: NIPPON ELECTRIC GLASS CO., LTD., Otsu-shi, Shiga (JP)

(72) Inventors: Takumi KINOSHITA, Otsu-shi, Shiga (JP); Naoki FUJITA, Otsu-shi, Shiga (JP)

(21) Appl. No.: 18/688,039

(22) PCT Filed: Aug. 30, 2022
(86) PCT No.: PCT/JP2022/032545

§ 371 Date: Feb. 29, 2024

(30) Foreign Application Priority Data
Sep. 6, 2021 (JP) 2021-145015

(51) Int. Cl. G06F 1/16; B24C 1/06; C03C 19/00; G06F 3/0354; G06F 3/041

(52) U.S. Cl. CPC G06F 1/1643; G06F 1/1626; G06F 3/03545; B24C 1/06; C03C 19/00; G06F 3/041

(57) ABSTRACT

Provided are a glass member that excels in tactile sensation such as the feel of writing using an input pen and the feel of touching with a fingertip, an input device provided with the glass member, a pen input device, a mobile apparatus, and a method for manufacturing the glass member. At least a portion of a principal surface 21a has minute uneven 10, and the coefficient of determination R² of a regression line L (La) is 0.600-0.960, the regression line L (La) being obtained by performing simple regression analysis through a least square method upon a range in areal material ratio from 10% to 99% of an areal material ratio curve T (Ta) of an area within a square region of the minute uneven 10, one side of the square region measuring 5 μm.

### TECHNICAL FIELD

The present invention relates to techniques of a glass member, an input device provided with the glass member, a pen input device, a mobile apparatus, and a method for manufacturing the glass member.

### BACKGROUND ART

Conventionally, there has been known an input device, such as a touch panel, which can perform an input operation of a character, a figure, or the like with an input pen or a fingertip.

In such an input device, a transparent glass substrate made of a glass member is disposed as a cover member on a front surface side (front side) of a display device, such as a liquid crystal display, and various input operations can be performed by moving the input pen or the fingertip in contact with a surface (principal surface) of the glass substrate.

Here, the surface of the cover member is imparted with minute recesses and projections in advance, for example, for the purpose of improving tactile sensation such as the feel of writing using the input pen and the feel of touching with the fingertip. Further, recently, there is an increasing demand for higher quality of the tactile sensation.

Therefore, as a technique for further improving the tactile sensation (feel of writing), for example, Patent Literature 1 discloses a glass substrate for a pen input device, the glass substrate whose surface has an uneven shape with an arithmetical mean roughness Ra of 0.19 μm to 0.45 μm and a mean interval Sm of 30 μm to 80 μm.

### CITATIONS LIST

### Patent Literature

Patent Literature 1: JP-A 2016-9393 Gazette

### SUMMARY OF INVENTION

### Technical Problems

However, in the glass substrate in Patent Literature 1 described above, it is easy to obtain a good feel of writing using respect to a stylus core made of polyacetal, which is a relatively hard material, but there is a possibility that the recesses and projections are too large for a stylus core made of elastomer, which is a relatively soft low modulus material, and a fingertip so that catching becomes strong, which leads to deterioration of feel of writing and feel of touching.

The present invention has been made in view of the above-described current problems, and an object thereof is to provide a glass member that excels in tactile sensation such as the feel of writing using an input pen and the feel of touching with a fingertip, an input device provided with the glass member, a pen input device, a mobile apparatus, and a method for manufacturing the glass member.

### Solutions to Problems

The problems to be solved by the present invention are as described above, and solutions to the problems will be described next.

That is, a glass member according to the present invention has minute recesses and projections on at least a portion of a surface, in which a coefficient of determination R² of a regression line is 0.600 to 0.960, the regression line being obtained by performing simple regression analysis through a least square method upon a range in areal material ratio from 10% to 99% of an areal material ratio curve of an area within a square region of the minute uneven, one side of the square region measuring 5 μm.

With such a configuration, according to the glass member of the present invention, when a pen nib or a fingertip of an input pen is moved in contact with the surface of the glass member, a contact area is appropriately reduced by the presence of the recesses (valleys) in the minute recesses and projections, so that the pen nib or the fingertip is appropriately slippery. Further, the presence of the projections (peaks) in the minute recesses and projections causes an appropriate feel of being caught, so that a frictional force between the surface of the glass member and the pen nib of the input pen or the fingertip can be appropriately adjusted to improve tactile sensation such as the feel of writing using the input pen and feel of touching with the fingertip.

Further, the glass member according to the present invention has minute recesses and projections on at least a portion of a surface, in which, in an areal material ratio curve of an area within a square region of the minute recesses and projections, one side of the square region measuring 5 μm, a ratio (d/h) of a root mean square error d between the areal material ratio curve and a regression line to a maximum height h (=ha−hb) is 0.045 to 0.165, the regression line being obtained by performing simple regression analysis through a least square method upon a range in areal material ratio from 10% to 99%, and the maximum height h being a difference between a height ha at the areal material ratio of 1% and a height hb at the areal material ratio of 99%.

With such a configuration, according to the glass member of the present invention, when the pen nib of the input pen or the fingertip is moved in contact with the surface of the glass member, the contact area is appropriately reduced due to the presence of the recesses (valleys) so that excessive adhesion at the time of contact can be suppressed, and the pen nib or the fingertip is appropriately slippery. Further, the appropriate feel of being caught is felt due to the presence of the projections (peaks), so that the tactile sensation such as the feel of writing using the input pen and the feel of touching with the fingertip can be improved.

Further, the glass member according to the present invention has minute recesses and projections on at least a portion of a surface, in which, in an areal material ratio curve of an area within a square region of the minute uneven, one side of the square region measuring 5 μm, a ratio (Vvv/Vmp) of a void volume Vvv of reduced valleys to a material volume Vmp of reduced peaks is 2.4 to 15 when an areal material ratio indicating a boundary between a core surface and the reduced peaks in the minute uneven is 10% and an areal material ratio indicating a boundary between the core surface and the reduced valleys in the minute uneven is 80%.

With such a configuration, according to the glass member of the present invention, it is possible to sufficiently expect the effect of reducing the contact area with the pen nib of the input pen or the fingertip due to the recesses (valleys), and the pen nib or the fingertip is appropriately slippery when the pen nib of the input pen or the fingertip is moved in contact with the surface of the glass member. Further, the appropriate feel of being caught is felt due to the presence of the projections (peaks), so that the tactile sensation such as the feel of writing using the input pen and the feel of touching with the fingertip can be improved.

Further, in the glass member according to the present invention, in the minute uneven, an arithmetical mean height Sa of roughness profile elements is preferably 1 nm to 100 nm.

With such a configuration, according to the glass member of the present invention, it is possible to more reliably improve the tactile sensation such as the feel of writing using the input pen and the feel of touching with the fingertip by the effect of reducing the contact area between the minute uneven, provided on the surface of the glass member, and the pen nib of the input pen or the fingertip and the appropriate feel of being caught due to an uneven shape.

Further, scattering of light due to the uneven shape of the minute uneven can be minimized, and visibility on the surface of the glass member on which the minute uneven are formed can be more reliably ensured.

Further, an input device according to the present invention includes: a glass substrate made of any of the glass members described above: a display device that displays an image; and a detection circuit that detects an input position.

With such a configuration, it is possible to realize the input device that excels in tactile sensation such as the feel of writing using the input pen and the feel of touching with the fingertip.

Further, a pen input device according to the present invention includes: the above-described input device: an input pen that performs an input operation on the input device by being moved in contact with a surface of the glass substrate.

With such a configuration, it is possible to realize the pen input device that excels in tactile sensation such as the feel of writing using the input pen and the feel of touching with the fingertip.

Further, a mobile apparatus according to the present invention includes a back cover member including any of the glass members described above.

With such a configuration, it is possible to realize the mobile apparatus that excels in tactile sensation such as the feel of touching with the fingertip.

Further, a method for manufacturing a glass member according to the present invention is a method for manufacturing any of the glass members described above, and includes performing a wet blasting treatment or a sand blasting treatment on the surface of the glass member.

With such a configuration, by the method for manufacturing a glass member according to the present invention, it is possible to manufacture the glass member having the minute uneven formed on the surface, the glass member being excellent in tactile sensation such as the feel of writing using the input pen and the feel of touching with the fingertip as compared with a smooth flat surface not provided with the minute uneven.

### Advantageous Effects of Invention

As effects of the present invention, the following effects are obtained.

That is, the glass member, the input device provided with the glass member, the pen input device, the mobile apparatus, and the method for manufacturing the glass member according to the present invention enable excellent tactile sensation such as the feel of writing using the input pen and the feel of touching with the fingertip.

### BRIEF DESCRIPTION OF DRAWINGS

FIG. 1 is a schematic cross-sectional side view illustrating a configuration of a pen input device according to an embodiment of the present invention.

FIG. 2 is a view for describing a relationship between profiles of minute uneven and an areal material ratio curve of an area.

FIG. 3A and FIG. 3B are views for describing a case where a coefficient of determination R² of a regression line is 0.600 to 0.960 in a relationship between an areal material ratio curve of an area and the regression line obtained by performing simple regression analysis of the areal material ratio curve through a least square method, in which FIG. 3A is a view schematically illustrating profiles of minute uneven in this case, and FIG. 3B is a view illustrating the relationship between the areal material ratio curve of the area and the regression line in this case.

FIG. 4A and FIG. 4B are views for describing a case where a coefficient of determination R² of a regression line exceeds 0.96 in a relationship between an areal material ratio curve of an area and the regression line obtained by performing simple regression analysis of the areal material ratio curve through a least square method, in which FIG. 4A is a view schematically illustrating profiles of minute uneven in this case, and FIG. 4B is a view illustrating the relationship between the areal material ratio curve and the regression line in this case.

FIG. 5A and FIG. 5B are views for describing another case of the case where the coefficient of determination R² of the regression line exceeds 0.96 in the relationship between the areal material ratio curve of the area and the regression line obtained by performing the simple regression analysis of the areal material ratio curve through the least square method, in which FIG. 5A is a view schematically illustrating profiles of minute uneven in this case, and FIG. 5B is a view illustrating the relationship between the areal material ratio curve and the regression line in this case.

FIG. 6A and FIG. 6B are views for describing a case where a coefficient of determination R² of a regression line is less than 0.600 in a relationship between an areal material ratio curve of an area and the regression line obtained by performing simple regression analysis of the areal material ratio curve through a least square method, in which FIG. 6A is a view schematically illustrating profiles of minute uneven in this case, and FIG. 6B is a view illustrating the relationship between the areal material ratio curve and the regression line in this case.

FIG. 7 is a view for describing a ratio (d/h) of a root mean square error d between an areal material ratio curve of an area and the regression line to a maximum height h within a range in areal material ratio from 1% to 99% of the areal material ratio curve.

FIG. 8 is a view for describing an arithmetical mean height Sa which is a parameter representing a surface roughness of minute uneven.

FIG. 9 is a schematic view illustrating a mobile apparatus according to another embodiment of the present invention.

### DESCRIPTION OF EMBODIMENTS

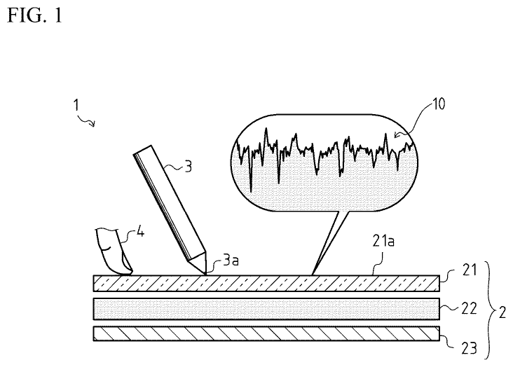

Next, one embodiment of the present invention will be described with reference to FIG. 1 to FIG. 9.

### [Overall Configuration of Pen Input Device 1]

First, an overall configuration of a pen input device 1 embodied in the present embodiment will be described with reference to FIG. 1.

The pen input device 1 includes: an input device 2 having a glass substrate 21 made of a glass member according to the present invention; and an input pen 3 that performs an input operation on the input device 2 by being moved in contact with a surface (more specifically, a principal surface 21a) of the glass substrate 21.

The input device 2 mainly includes: the glass substrate 21 provided as a cover member; a display element 22 that is an example of a display device and displays an image; and a digitizer circuit 23 that is an example of a detection circuit and detects information (more specifically, an input position of the input pen 3 or a fingertip 4) input by the input pen 3 and the fingertip 4.

The glass substrate 21, the display element 22, and the digitizer circuit 23 are stacked on each other such that the glass substrate 21 is disposed on the front side of the display element 22, and the digitizer circuit 23 is disposed on the back side of the display element 22.

Note that, in the above description, the “front side” of the display element 22 means a side on which an image is displayed, and the “back side” of the display element 22 means a side opposite to the side on which an image is displayed.

In the present embodiment, for example, the “front side” of the display element 22 is the upper side of the paper plane in FIG. 1, and the “back side” of the display element 22 is the lower side of the paper plane in FIG. 1.

Then, the pen input device 1 is configured to be capable of executing input operations of a character, a figure, and the like by moving the pen nib 3a of the input pen 3 and the fingertip 4 in the state of being in contact with the surface of the glass substrate 21 (the principal surface 21a on a side opposite to the display element 22 side with respect to the glass substrate 21), and detecting positions (input positions) of the pen nib 3a and the fingertip 4 by the digitizer circuit 23.

Examples of such a pen input device 1 include a tablet terminal.

Note that the tablet terminal broadly means an input display device having both a display function and an input function, and includes apparatuses such as a liquid crystal pen tablet, a tablet PC, a mobile PC, a smartphone, and a game machine.

The glass substrate 21 is formed using a plate-like transparent glass member having minute uneven (hereinafter referred to appropriately as minute uneven 10) formed on at least one surface (in the present embodiment, the principal surface 21a).

Further, the glass substrate 21 is disposed such that the principal surface 21a on which the minute uneven 10 are formed is a plane on a side with which the input pen 3 or the fingertip 4 comes into contact.

Here, examples of a material of the glass substrate 21 include quartz glass, soda lime glass, alkali-free glass, aluminosilicate glass, borosilicate glass, and chalcogenide glass.

Further, in a case where the glass substrate 21 is formed using a glass member made of alkali-containing aluminosilicate glass, the glass substrate 21 may have a chemically strengthened layer on the principal surface 21a.

Further, a functional film that imparts a specific function can be provided on the principal surface 21a of the glass substrate 21.

For example, an antireflection film for reducing a reflectance on the side with which the input pen 3 and the fingertip 4 come into contact and/or an antifouling film for preventing adhesion of a fingerprint and imparting water repellency and oil repellency may be formed.

As the antireflection film, for example, a low refractive index film having a refractive index lower than that of the glass substrate 21, or a dielectric multilayer film in which a low refractive index film having a relatively low refractive index and a high refractive index film having a relatively high refractive index are alternately laminated is used.

Further, the antireflection film can be formed by a sputtering method, a CVD method, or the like.

On the other hand, the antifouling film preferably contains an organosilicon compound, a fluoropolymer containing silicon in the main chain, and the like.

Note that, when the principal surface 21a on the front surface side of the glass substrate 21 has the antireflection film and the antifouling film, it is preferable to form the antireflection film on the principal surface 21a of the glass substrate 21 and form the antifouling film on the antireflection film.

Further, when the functional film is formed on the principal surface 21a of the glass substrate 21, the minute uneven 10 of the principal surface 21a of the glass substrate 21 are formed such that uneven on a surface of the functional film fall within a predetermined range of surface roughness described later.

Note that details of the glass substrate 21 will be described later.

The digitizer circuit 23 includes a detection sensor that detects an input operation by the input pen 3 or the fingertip 4.

Here, the input pen 3 is an input instrument having a shape similar to that of a writing instrument such as a pencil or a ballpoint pen, and has the pen nib 3a, which is an example of a friction element brought into contact with the glass substrate 21, and the pen nib 3a is made of a synthetic resin material such as an elastomer or a polyacetal resin, a conductive fiber, or felt.

The pen nib 3a made of the above-described member in the input pen 3 is likely to be caught even by the minute uneven 10 provided on the principal surface 21a of the glass substrate 21.

Therefore, when the pen nib 3a of the input pen 3 is moved in contact with the principal surface 21a of the glass substrate 21 on which the minute uneven 10 are formed, particularly excellent feel of writing can be achieved.

### [Configuration of Glass Substrate 21]

Next, a configuration of the glass substrate 21 will be described in detail with reference to FIG. 1 to FIG. 8.

As described above, the glass substrate 21 is an example of the glass member according to the present invention, and is formed in a rectangular flat plate shape, for example, as illustrated in FIG. 1.

Note that the shape of the glass substrate 21 is not limited to the present embodiment, and may be, for example, any shape such as a flat plate shape having a circular or polygonal outline, or a shape obtained by curving a flat plate shape as a whole.

In the glass substrate 21, the minute uneven 10 are formed on one surface (in the present embodiment, the principal surface 21a).

Here, the minute uneven 10 are provided on the principal surface 21a of the glass substrate 21 mainly for the purpose of appropriately adjusting a frictional force generated between the input pen 3 and the pen nib 3a or the fingertip 4.

Therefore, the minute uneven 10 only need to be formed in at least a partial region of the principal surface 21a where it is necessary to improve the tactile sensation such as the feel of writing using the input pen 3 and the feel of touching with the fingertip 4 according to a final use state of the glass substrate 21, and are formed on the entire the principal surface 21a in the present embodiment.

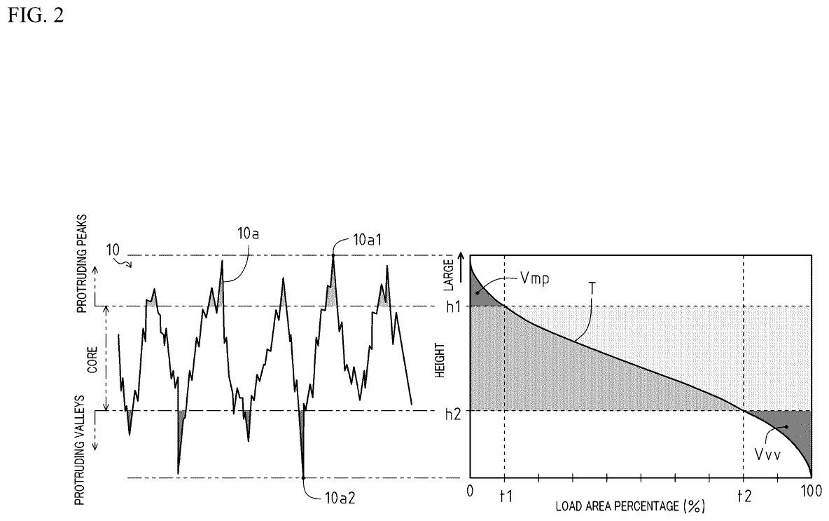

As described below, shapes of the minute uneven 10 are set using an areal material ratio curve T of an area (see FIG. 2) representing the proportion of uneven of the area and various three-dimensional surface roughness parameters (a void volume Vvv of reduced valleys, a material volume Vmp of reduced peaks, and an arithmetical mean height Sa) defined by ISO 25178.

Here, the areal material ratio curve T of the area is a curve representing a ratio between projections (peak) and recesses (valleys) of an uneven shape of the area with respect to the height direction, and is a cumulative distribution function representing an area ratio of the projections (peaks).

Specifically, as illustrated in FIG. 2, the areal material ratio curve T of the area is represented by a vertical axis indicating a height of the uneven shape and a horizontal axis indicating a areal material ratio of the projections (peaks) and expressed as a substantially S-shaped curve, for example, when an uppermost end portion 10al of the projections (peaks) is set to the areal material ratio of 0% and a lowermost end portion 10a2 of the recesses (valleys) is set to the areal material ratio of 100% in an profile 10a indicating the shapes of the minute uneven 10.

Note that the areal material ratio described above represents the proportion of area occupied by a region where the projections (peaks) having a certain height or more exist.

In the areal material ratio curve T of the area, the minute uneven 10 include: reduced peaks occupying a region equal to or higher than a height h1 when the areal material ratio is t1 (%); reduced valleys occupying a region equal to or lower than a height h2 (>h1) when the areal material ratio is t2 (%) higher than t1 (%); and a core surface occupying a region between the reduced peaks and the reduced valleys. [Setting Condition of Coefficient of Determination R²]

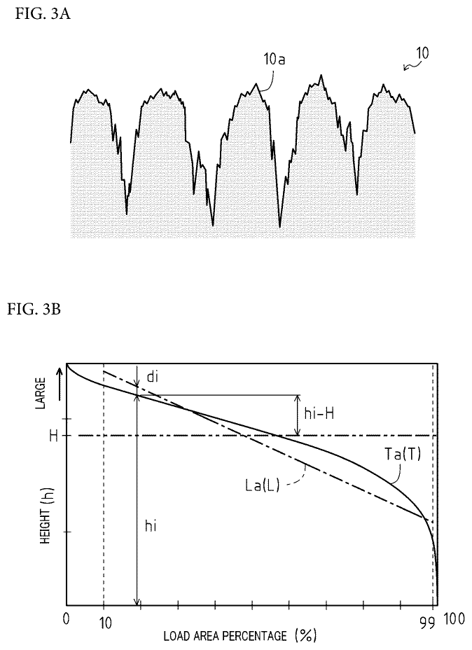

As illustrated in FIG. 3A and FIG. 3B, the shapes of the minute uneven 10 in the present embodiment are set such that a coefficient of determination R² of a regression line L (regression line La illustrated in FIG. 3B) is 0.600 to 0.960, the regression line L being obtained by performing simple regression analysis through a least square method upon a range in areal material ratio from 10% to 99% of an areal material ratio curve T (an areal material ratio curve Ta of an area illustrated in FIG. 3B) of an area in a square region having one side measuring 5 μm in the minute uneven 10.

Here, the coefficient of determination R² is expressed by the following mathematical expression (formula 1), and is obtained by subtracting a value, obtained by dividing the sum of squares of residuals di between the areal material ratio curve T and the regression line L by a sum of squares of differences between a height hᵢ and a mean height H of the height hᵢ from 1.

Note that the mean height H is a mean value ((h₁+h₂+··· hi)/i) of the heights hi in the range in the areal material ratio from 10% to 99%.

$${R}^{2} = 1 - \frac{\sum {di}^{2}}{\sum {( hi - H )}^{2}} \qquad [ Formula 1 ]$$

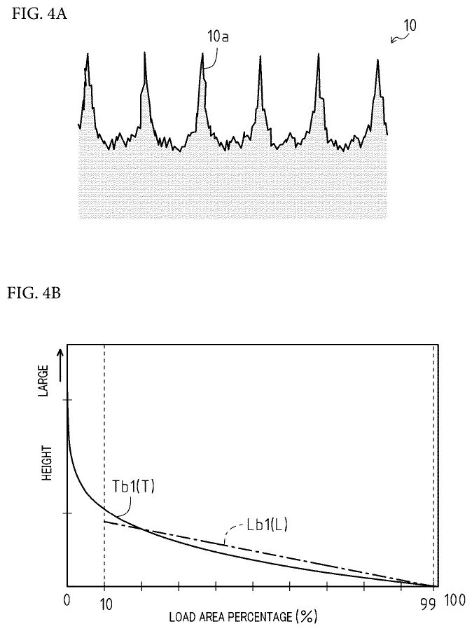

Then, as illustrated in FIG. 4A, in a case where projections (peaks) of the profile 10a have a sharply pointed shape in the minute uneven 10, an areal material ratio of the areal material ratio curve T of an area of the minute uneven 10 (an areal material ratio curve Tb1 of an area illustrated in FIG. 4B) rapidly increases at a low height position, and a shape of the areal material ratio curve Tb1 of the area in a range in the areal material ratio from 10% to 99% excluding reduced peaks, for example, when the areal material ratio t1, which is a boundary between the reduced peaks and a core surface, is 10% (t1=10%) approximates the regression line L (a regression line Lb1 illustrated in FIG. 4B) as illustrated in FIG. 4B.

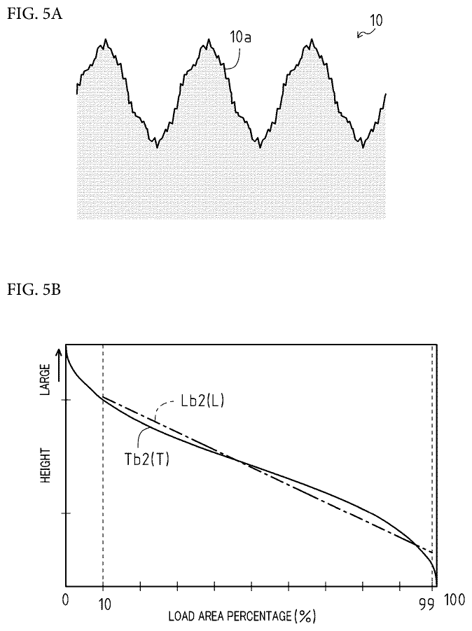

Further, as illustrated in FIG. 5A, in a case where projections (peaks) and recesses (valleys) of the profile 10a have a substantially regularly repeated triangular wave shape in the minute uneven 10, an areal material ratio of the areal material ratio curve T of an area of the minute uneven 10 (an areal material ratio curve Tb2 of the area illustrated in FIG. 5B) increases at a substantially constant rate as the height decreases. Thus, a shape of the areal material ratio curve Tb2 of the area in a range in the areal material ratio from 10% to 99% excluding reduced peaks, for example, when the areal material ratio t1, which is a boundary between the reduced peaks and a core surface, is 10% (t1=10%) approximates the regression line L (a regression line Lb2 illustrated in FIG. 5B) as illustrated in FIG. 4B.

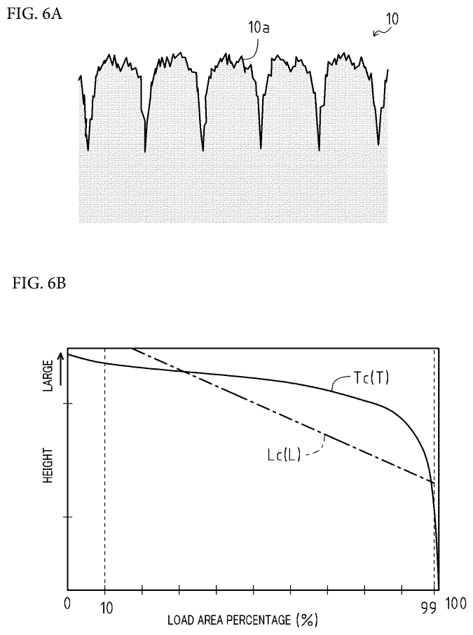

Further, as illustrated in FIG. 6A, in a case where the profile 10a has a shape in which recesses (valleys) are deeply and sharply notched, and projections (peaks) have relatively smooth roundness in the minute uneven 10, an areal material ratio of the areal material ratio curve T of an area of the minute uneven 10 (an areal material ratio curve Tc of an area illustrated in FIG. 6B) rapidly increases at a high height position, and a shape of the areal material ratio curve Tc of the area in a range in the areal material ratio from 10% to 99% excluding reduced peaks, for example, when the areal material ratio t1, which is a boundary between the reduced peaks and a core surface, is 10% (t1=10%) is a curve greatly deviated from the regression line L (a regression line Lc illustrated in FIG. 6B) as illustrated in FIG. 6B.

In this manner, in a relationship between the areal material ratio curve T of the area and the regression line L in the profile 10a of the minute uneven 10, the shape of the profile 10a tends to be an uneven shape in which the projections (peaks) are pointed or an uneven shape of a triangular wave shape as the shape of the areal material ratio curve T of the area in the range in the areal material ratio from 10% to 99% excluding the reduced peaks approximates the regression line L, whereas the shape of the profile 10a tends to be an uneven shape in which the recesses (valleys) are deeply and sharply notched and the projections (peaks) have relatively smooth roundness as the deviation from the regression line L increases.

In the present embodiment, in consideration of such a point of view, the coefficient of determination R² of the regression line L (La), which is an index of the linearity of the areal material ratio curve T (Ta) of the area in the range in the areal material ratio from 10% to 99%, is set within a predetermined range such that the principal surface 21a of the glass substrate 21 is imparted with the minute uneven 10 having an appropriate uneven shape in which projections (peaks) are not excessively pointed and deep recesses (valleys) are provided.

Specifically, as illustrated in FIGS. 4A to 5B, in a case where the coefficient of determination R² of the regression line L (Lb1 and Lb2) exceeds 0.96 (R²>0.96), the minute uneven 10 provided on the principal surface 21a of the glass substrate 21 have the uneven shape in which the projections (peaks) whose projecting end portions are steeply pointed exist. Thus, the feel of being caught felt at the time of moving the pen nib 3a of the input pen 3 or the fingertip 4 (see FIG. 1) in contact with the principal surface 21a of the glass substrate 21 becomes too strong, and the tactile sensation such as the feel of writing using the input pen 3 and the feel of touching with the fingertip 4 deteriorates.

On the other hand, as illustrated in FIG. 6A and FIG. 6B, in a case where the coefficient of determination R² of the regression line L (Lc) is less than 0.600 (R²<0.600), the minute uneven 10 provided on the principal surface 21a of the glass substrate 21 have the uneven shape in which the deeply and sharply notched recesses (valleys) exist, and the proportion of a region of the recesses (valleys) in the entire minute uneven 10 is relatively small. Thus, it is difficult to expect an effect of reducing a contact area with the pen nib 3a of the input pen 3 or the fingertip 4, and the input pen 3 or the fingertip 4 is less slippery with respect to the principal surface 21a of the glass substrate 21.

Further, projecting end portions of the projections (peaks) of the minute uneven 10 have a relatively smooth shape, and thus, it is difficult to have the feel of being caught when the pen nib 3a of the input pen 3 or the fingertip 4 is moved in contact with the principal surface 21a of the glass substrate 21.

Thus, the tactile sensation such as the feel of writing using the input pen 3 and the feel of touching with the fingertip 4 deteriorates.

For this reason, as illustrated in FIG. 3A and FIG. 3B, the coefficient of determination R² of the regression line L (La) is set to 0.600 to 0.960 (0.600≤R²≤ 0.960) in the present embodiment. Since the shapes of the minute uneven 10 provided on the principal surface 21a of the glass substrate 21 are controlled by such a simple method, the minute uneven 10 are formed in an uneven shape including recesses (valleys) notched with an appropriate gap and projections (peaks) whose projecting end portions are appropriately pointed.

As a result, according to the glass substrate 21 of the present embodiment, when the pen nib 3a of the input pen 3 or the fingertip 4 is moved in contact with the principal surface 21a of the glass substrate 21, the contact area is appropriately reduced due to the presence of the recesses (valleys) so that the pen nib 3a or the fingertip 4 is appropriately slippery. Further, the appropriate feel of being caught is felt due to the presence of the projections (peaks), so that the frictional force between the principal surface 21a of the glass substrate 21 and the pen nib 3a of the input pen 3 or the fingertip 4 is appropriately adjusted, and the tactile sensation such as the feel of writing using the input pen 3 and the feel of touching with the fingertip 4 can be improved.

Note that an upper limit value of the coefficient of determination R² of the regression line L (La) is 0.960, but is preferably 0.950, and more preferably 0.940.

Further, a lower limit value of the coefficient of determination R² of the regression line L (La) is 0.600, but is preferably 0.630, and more preferably 0.650.

[Setting Condition of Ratio (d/h)]

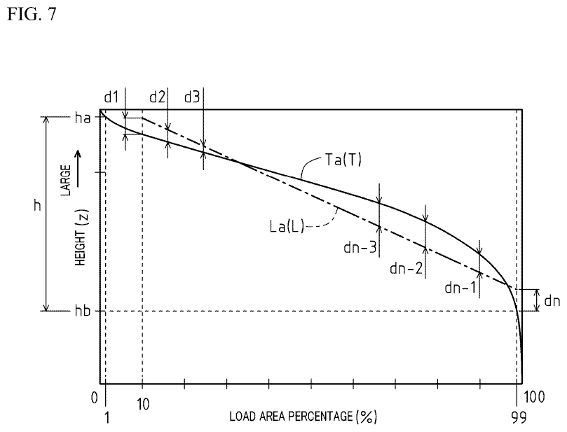

As illustrated in FIG. 7, the shapes of the minute uneven 10 in the present embodiment are set such that a ratio (d/h) of a root mean square error d between the areal material ratio curve T (Ta) and the regression line L (La) to a maximum height h of the areal material ratio within a range from 1% to 99% of the areal material ratio curve T (Ta) of the area is 0.045 to 0.165.

Note that the maximum height h is a difference (h=ha−hb) between a height ha at the areal material ratio of 1% and a height hb at the areal material ratio of 99% of the areal material ratio curve T (Ta) of the area.

Further, as described above, the regression line L (La) is a regression line obtained by performing simple regression analysis through a least square method upon the range in the areal material ratio from 10% to 99% of the areal material ratio curve T (Ta) of the area.

Here, the root mean square error d indicates the amount of deviation between the areal material ratio curve T of the area and the regression line L (how much the areal material ratio curve T of the area within the range in the areal material ratio from 10% to 99% deviates from the regression line L), which is expressed by the following mathematical expression (formula 2), and is difficult to be simply compared between the minute uneven 10 having different surface roughnesses since the root mean square error d also increases as a roughness (difference in height between a projection (peak) and a recess (valley)) of the minute uneven 10 increases.

$$σ = \sqrt{\frac{1}{n} {\sum }_{i = 1}^{n} {di}^{2}} \qquad [ Formula 2 ]$$

Therefore, in the present embodiment, the ratio (d/h) of the maximum height h in the range in the areal material ratio from 1% to 99% of the areal material ratio curve T (Ta) of the area is used as an index indicating the amount of deviation between the areal material ratio curve T of the area in the range in the areal material ratio from 10% to 99% and the regression line L, so that the amount of deviation can be easily compared between the minute uneven 10 having different surface roughnesses.

Note that the ratio (d/h) is an index of the linearity of the areal material ratio curve T of the area when the areal material ratio is in the range from 10% to 99%.

In a case where the ratio (d/h) is less than 0.045 ((d/h)<0.045), the areal material ratio curve T of the area tends to be extremely close to the regression line L.

Thus, the minute uneven 10 provided on the principal surface 21a of the glass substrate 21 have an uneven shape in which deeply and sharply notched recesses (valleys) exist, and the proportion of a region of the recesses (valleys) in the entire minute uneven 10 is relatively small. Thus, it is difficult to expect the effect of reducing the contact area with the pen nib 3a of the input pen 3 or the fingertip 4, and the input pen 3 or the fingertip 4 (see FIG. 1) is less slippery with respect to the principal surface 21a of the glass substrate 21.

Alternatively, projecting end portions of the recesses (valleys) of the minute uneven 10 have a relatively smooth shape, and thus, it is difficult to have the feel of being caught when the pen nib 3a of the input pen 3 or the fingertip 4 is moved in contact with the principal surface 21a of the glass substrate 21.

Thus, the tactile sensation such as the feel of writing using the input pen and the feel of touching with the fingertip deteriorates.

On the other hand, in a case where the ratio (d/h) exceeds 0.165 ((d/h)>0.165), the areal material ratio curve T of the area tends to deviate relatively greatly from the regression line L.

Thus, the minute uneven 10 provided on the principal surface 21a of the glass substrate 21 have an uneven shape in which projections (peaks) whose projecting end portions are steeply pointed exist. Thus, the feel of being caught felt at the time of moving the pen nib 3a of the input pen 3 or the fingertip 4 in contact with the principal surface 21a of the glass substrate 21 becomes too strong, and the tactile sensation such as the feel of writing using the input pen 3 and the feel of touching with the fingertip 4 deteriorates.

For this reason, the ratio (d/h) is set to 0.045 to 0.165 (0.045≤ (d/h)≤0.165) in the present embodiment such that the minute uneven 10 provided on the principal surface 21a of the glass substrate 21 are reliably configured by recesses (valleys) notched with an appropriate gap and projections (peaks) whose projecting end portions are appropriately pointed.

As a result, according to the glass substrate 21 of the present embodiment, when the pen nib 3a of the input pen 3 or the fingertip 4 is moved in contact with the principal surface 21a of the glass substrate 21, the contact area is appropriately reduced due to the presence of the recesses (valleys) so that excessive adhesion at the time of contact can be suppressed, and the pen nib 3a or the fingertip 4 is appropriately slippery. Further, the appropriate feel of being caught is felt due to the presence of the projections (peaks), so that the tactile sensation such as the feel of writing using the input pen 3 and the feel of touching with the fingertip 4 can be improved.

Note that an upper limit value of the ratio (d/h) is 0.165, but is preferably 0.160, and more preferably 0.150.

Further, a lower limit value of the ratio (d/h) is 0.045, but is preferably 0.050, and more preferably 0.055.

### [Setting Conditions of Ratio (Vvv/Vmp)]

The shapes of the minute uneven 10 in the present embodiment are set such that a ratio (Vvv/Vmp) of the void volume Vvv of reduced valleys to the material volume Vmp of reduced peaks is 2.4 to 15 when an areal material ratio indicating a boundary between a core surface and the reduced peaks in the minute uneven 10 is 10% (t1=10%) and an areal material ratio indicating a boundary between the core surface and the reduced valleys in the minute uneven 10 is 80% (t2=80%) in the areal material ratio curve T (Ta) of the area described above.

Here, both the material volume Vmp of reduced peaks and the void volume Vvv of reduced valleys are parameters defined by ISO 25178, and are derived based on an areal material ratio curve T of an area.

Specifically, as illustrated in FIG. 2, the material volume Vmp of reduced peaks represents a material volume of projections (peaks) at an areal material ratio of t1 (%) of the areal material ratio curve T of the area.

In the present embodiment, the material volume of the projections (peaks) when the areal material ratio t1 is 10% is obtained as the material volume Vmp of reduced peaks. That is, the areal material ratio t1 indicating a boundary between a core surface and the reduced peaks in the minute uneven 10 is set to 10%.

Note that an uneven shape of the minute uneven 10 tends to have more steeply pointed projections (peaks) as a value of the material volume Vmp increases.

Further, the void volume Vvv of reduced valleys represents a void volume of recesses (valleys) at an areal material ratio of t2 (%) of the areal material ratio curve T of the area.

In the present embodiment, the void volume of the recesses (valleys) when the areal material ratio t2 is 80% is obtained as the void volume Vvv of reduced valleys. That is, the areal material ratio t2 indicating a boundary between the core surface and the reduced valleys in the minute uneven 10 is set to 80%.

Note that an uneven shape of the minute uneven 10 tends to have more deep and sharp recesses (valleys) as a value of the void volume Vvv increases.

Further, the ratio (Vvv/Vmp) is a ratio of parameters including the material volume Vmp and the void volume Vvv, and thus, is an index indicating a balance between the steeply pointed projections (peaks) contributing to the feel of being caught and deep and sharp recesses (valleys) contributing to the reduction in the contact area with respect to the pen nib 3a of the input pen 3 and the fingertip 4 (see FIG. 1).

In a case where the ratio (Vvv/Vmp) is less than 2.4 ((Vvv/Vvp)<2.4), the proportion of the recesses (valleys) is relatively small in the minute uneven 10 provided on the principal surface 21a of the glass substrate 21, and thus, it is difficult to expect the effect of reducing the contact area with the pen nib 3a of the input pen 3 or the fingertip 4, and the pen nib 3a or the fingertip 4 is less likely to slippery and easily adheres to the principal surface 21a of the glass substrate 21, so that the tactile sensation such as the feel of writing using the input pen 3 and the feel of touching with the fingertip 4 deteriorates.

On the other hand, in a case where the ratio (Vvv/Vmp) exceeds 15 ((Vvv/Vvp)>15), the proportion of the projections (peaks) is relatively small in the minute uneven 10 provided on the principal surface 21a of the glass substrate 21, and thus, it is difficult to have the feel of being caught when the pen nib 3a of the input pen 3 or the fingertip 4 is moved in contact with the principal surface 21a of the glass substrate 21, and the tactile sensation such as the feel of writing using the input pen 3 and the feel of touching with the fingertip 4 deteriorates.

For this reason, in the present embodiment is configured such that the ratio (Vvv/Vvp) is set to 2.4 to 15 (2.4≤ (Vvv/Vvp)≤15), and the proportion of the projections (peaks) and the proportion of the recesses (valleys) are appropriate allocations to each other in the minute uneven 10 provided on the principal surface 21a of the glass substrate 21.

As a result, according to the glass substrate 21 of the present embodiment, it is possible to sufficiently expect the effect of reducing the contact area with the pen nib 3a of the input pen 3 or the fingertip 4 due to the recesses (valleys), and the pen nib 3a or the fingertip 4 is appropriately slippery when the pen nib 3a of the input pen 3 or the fingertip 4 is moved in contact with the principal surface 21a of the glass substrate 21. Further, the appropriate feel of being caught is felt due to the presence of the projections (peaks), so that the tactile sensation such as the feel of writing using the input pen 3 and the feel of touching with the fingertip 4 can be improved.

Note that an upper limit value of the ratio (Vvv/Vmp) is 15, but is preferably 14, and more preferably 13.

Further, a lower limit value of the ratio (Vvv/Vmp) is 2.4, but is preferably 2.5, and more preferably 2.6.

### [Setting Conditions of Arithmetical Mean Height Sa]

In the minute uneven 10 in the present embodiment, the arithmetical mean height Sa of roughness profile elements is set to be 1 nm to 100 nm.

Here, the arithmetical mean height Sa is a parameter defined by ISO 25178, and is a parameter obtained by expanding elements of the profile 10a, which is a line, to a plane.

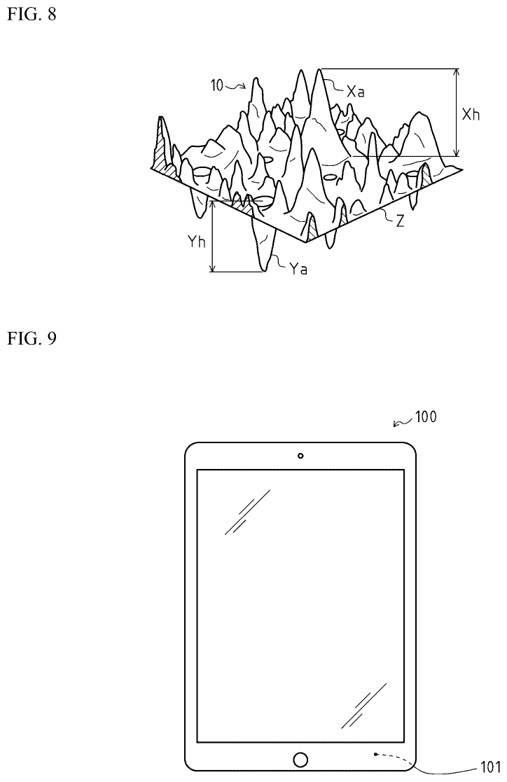

Specifically, as illustrated in FIG. 8, the arithmetical mean height Sa represents a mean of absolute values of separation distances (for example, a height Xh up to an apex of a projection (peak) Xa and a depth Yh up to an apex of a recess (valley) Ya) of respective points of an uneven shape constituting the minute uneven 10 with respect to a mean plane Z in the principal surface 21a of the glass substrate 21 (Sa=((Xh₁+Xh₂+···+Xhₙ)+(Yh₁+Yh₂+···+Yhₙ))/2n).

In a case where the arithmetical mean height Sa is less than 1 nm (Sa<1 nm), the frictional force between the minute uneven 10 provided on the principal surface 21a of the glass substrate 21 and the pen nib 3a of the input pen 3 or the fingertip 4 becomes too large, and the tactile sensation such as the feel of writing using the input pen 3 and the feel of touching with the fingertip 4 deteriorates.

On the other hand, in a case where the arithmetical mean height Sa exceeds 100 nm (Sa>100 nm), light scattering is likely to occur due to the uneven shape of the minute uneven 10 provided on the principal surface 21a of the glass substrate 21, and transparency of the principal surface 21a of the glass substrate 21 is impaired, so that there is a possibility that the visibility deteriorates.

Further, a haze of the glass substrate 21 tends to deteriorate.

For this reason, the arithmetical mean height Sa is set to 1 nm to 100 nm (1 nm≤Sa≤100 nm) in the present embodiment, and the frictional force between the minute uneven 10 provided on the principal surface 21a of the glass substrate 21 and the pen nib 3a of the input pen 3 or the fingertip 4 is appropriately adjusted, so that it is possible to more reliably improve the tactile sensation such as the feel of writing using the input pen 3 and the feel of touching with the fingertip 4 by the effect of reducing the contact area between the minute uneven 10, provided on the principal surface 21a of the glass substrate 21, and the pen nib 3a of the input pen 3 or the fingertip 4 and the appropriate feel of being caught due to the uneven shape.

Further, the scattering of light due to the uneven shape of the minute uneven 10 can be minimized, and the visibility on the principal surface 21a of the glass substrate 21 on which the minute uneven 10 are formed can be more reliably ensured.

Note that an upper limit value of the arithmetical mean height Sa is 100 nm, but is preferably 80 nm, and more preferably 60 nm.

Further, a lower limit value of the arithmetical mean height Sa is 1 nm, but is preferably 2 nm, and more preferably 3 nm.

The uneven shape of the minute uneven 10 set using the areal material ratio curve T (Ta) of the area and various three-dimensional surface roughness parameters (the void volume Vvv of reduced valleys, the material volume Vmp of reduced peak, and the arithmetical mean height Sa) according to ISO 25178 as described above is not limited to the present embodiment.

That is, regarding the uneven shape of the minute uneven 10, the coefficient of determination R² of the regression line L (La), obtained by performing the simple regression analysis through the least square method on the areal material ratio curve T (Ta) of the area at the areal material ratio from 10% to 99%, may be set to 0.600 to 0.960.

Further, the ratio (d/h) of the root mean square error d between the areal material ratio curve T (Ta) of the area and the regression line L (La) in the range in the areal material ratio from 10% to 99% to the maximum height h in the range in the areal material ratio from 1% to 99% may be set to 0.045 to 0.165.

Further, the ratio (Vvv/Vmp) of the void volume Vvv of reduced valleys and the material volume Vmp of reduced peaks may be set to 2.4 to 15.

These are merely characteristics that specify the uneven shape of the minute uneven 10, and it is not always necessary to simultaneously satisfy the respective parameters.

For example, when the coefficient of determination R² of the regression line L (La), obtained by performing the simple regression analysis through the least square method on the areal material ratio curve T (Ta) of the area at the areal material ratio from 10% to 99% is 0.600 to 0.960, the other parameters, that is, the ratio (d/h) of the root mean square error d from the regression line L (La) in the range in the areal material ratio from 10% to 99% to the maximum height h in the range in the areal material ratio from 1% to 99%, or the ratio (Vvv/Vmp) of the void volume Vvv of reduced valleys to the material volume Vmp of reduced peaks may be out of the-described set range.

### [Method for Manufacturing Glass Substrate 21]

Next, a method for manufacturing the glass substrate 21 will be described with reference to FIG. 1.

The minute uneven 10 formed on at least a portion of the surface (the principal surface 21a) of the glass substrate 21 are formed by performing a wet blasting treatment, a sand blasting treatment, or the like on the principal surface 21a.

The wet blasting treatment is a treatment of forming a shape having minute uneven on a workpiece made of the glass substrate 21 by uniformly stirring abrasive grains formed of solid particles such as alumina and a liquid such as water using compressed air to form a slurry and spraying the slurry from a spray nozzle to the workpiece at a high speed.

In the wet blasting treatment, when the slurry sprayed at the high speed collides with the workpiece, the abrasive grains in the slurry scrape, strike, or rub a surface of the workpiece, so that the shape having minute uneven is formed on the surface of the workpiece.

In this case, since the abrasive grains sprayed to the workpiece and fragments of the workpiece scraped by the abrasive grains are washed away by the liquid sprayed to the workpiece, particles remaining on the workpiece decrease.

Further, in the wet blasting treatment, since the liquid carries the abrasive grains to the workpiece when the slurry is sprayed to the workpiece, finer abrasive grains can be used as compared with a dry sand blasting treatment, impact when the abrasive grains collide with the workpiece is reduced, and precise machining can be performed.

As the wet blasting treatment is performed on the workpiece (the glass substrate 21) in this manner, it is possible to easily form the shape having uneven at appropriate sizes on the principal surface 21a of the glass substrate 21, and it is possible to appropriately adjust the frictional force in the contact with the pen nib 3a of the input pen 3 or the fingertip 4 without impairing the transparency of the glass substrate 21, and reliably improve the tactile sensation such as the feel of writing and the feel of touching.

The sand blasting treatment is a treatment of forming a shape having minute uneven on a workpiece made of the glass substrate 21 by directly spraying abrasive grains formed of solid particles such as alumina from a spray nozzle to the workpiece at a high speed using compressed air.

As the sand blasting treatment is performed on the workpiece (the glass substrate 21), similarly to the above-described wet blasting treatment, it is also possible to easily form an uneven shape having an appropriate size on the principal surface 21a of the glass substrate 21, and it is possible to appropriately adjust the frictional force at the time of contact of the pen nib 3a of the input pen 3 or the fingertip 4 without impairing the transparency of the glass substrate 21, and reliably improve the tactile sensation such as the feel of writing and the feel of touching.

In this manner, the method for manufacturing the glass substrate 21 according to the present embodiment is characterized in that the minute uneven 10 satisfying the above-described predetermined condition are formed by performing the wet blasting treatment or the sand blasting treatment on at least a portion of the surface (the principal surface 21a) of the glass substrate 21.

According to the manufacturing method having such a configuration, it is possible to manufacture the glass substrate 21 having the minute uneven 10 formed on the principal surface 21a, the glass substrate 21 being excellent in tactile sensation such as the feel of writing using the input pen 3 and the feel of touching with the fingertip 4 as compared with a smooth flat surface not provided with the minute uneven 10.

Note that in the formation of the minute uneven 10 on the principal surface 21a of the glass substrate 21, a chemical etching treatment, a sol-gel method, nanoimprinting, or the like can be used as a treatment method other than the wet blasting treatment and the sand blasting treatment described above.

Here, the chemical etching treatment is a treatment of chemically etching the principal surface 21a of the glass substrate 21 with a hydrogen fluoride (HF) gas, an acid such as a hydrofluoric acid, a hydrochloric acid, or a sulfuric acid, an aqueous alkali solution such as sodium hydroxide, or the like.

### [Another Embodiment]

Meanwhile, in FIG. 9, the glass substrate 21 in the present embodiment can be used as a back cover member 101 constituting an exterior of a mobile apparatus 100 mainly focusing on the point of improving the feel of touching with the fingertip 4.

That is, as another embodiment of the present invention, the mobile apparatus 100 includes the back cover member 101 including the glass substrate 21 described above.

Here, examples of the mobile apparatus 100 having the back cover member 101 include a mobile phone, a smartphone, a personal data assistance (PDA), a portable navigation device (PND), a notebook computer, a tablet PC, and the like, which are communication terminals.

Then, with such a configuration, it is possible to realize the mobile apparatus 100 that excels in tactile sensation such as the feel of touching with the fingertip 4.

### EXAMPLES

Next, the glass member on which the minute uneven are formed according to the present invention will be described in detail with reference to Examples and Comparative Examples.

Note that the configuration of the glass member according to the present invention is not limited to the following Examples.

### [Preparation of Samples]

First, Samples 1 to 11 were prepared as Examples of the glass member according to the present invention.

Further, Samples 12 to 15 were prepared as Comparative Examples for these Examples.

As a material of Samples 1 to 11 as Examples, aluminosilicate glass (manufactured by Nippon Electric Glass Co., Ltd., product name: T2X-1) having a rectangular plate shape with a thickness of 0.5 mm was used.

Note that materials of Samples 12 to 15 as Comparative Examples will be described later.

Glass members of Samples 1 to 7 as Examples were subjected to a wet blasting treatment to form minute uneven on one principal surface.

Specifically, wet blasting was performed by uniformly stirring abrasive grains, made of alumina (Al₂O₃), as an abrasive and water to prepare a slurry, moving a nozzle at a predetermined scanning speed to scan the entire one principal surface of each of the glass members, and spraying the prepared slurry from the nozzle using air at a predetermined treatment pressure.

Here, polygonal abrasive grains having an average particle diameter of 1.2 μm were used for the glass members of Sample 1 to 3, polygonal abrasive grains having an average particle diameter of 3.0 μm were used for the glass members of Samples 4 and 5, and polygonal abrasive grains having an average particle diameter of 6.9 μm were used for the glass members of Samples 6 and 7.

Note that the average particle diameter is a particle diameter of an abrasive material measured with a median diameter as D₅₀.

Further, regarding the concentration of the slurry, a slurry having a concentration of abrasive grains of 6.0% by weight was used for the glass members of Sample 1 to 7.

Then, the treatment pressure of the air in the nozzle was set to 0.22 MPa for the glass members of Samples 1 and 2, 0.13 MPa for the glass member of Sample 3, 0.15 MPa for the glass members of Samples 4 and 6, and 0.25 MPa for the glass members of Samples 5 and 7.

Further, a distance (nozzle distance) between the glass member and a spray outlet of the nozzle was adjusted to be 4.0 mm for the glass members of Samples 1 to 7.

Furthermore, the scanning speed in movement of the nozzle was set to 1 mm/s for the glass member of Sample 1, 40 mm/s for the glass members of Samples 2 and 3, 20 mm/s for the glass members of Samples 4 and 6, and 10 mm/s for the glass members of Samples 5 and 7.

Glass members of Samples 8 to 11 as Examples were subjected to a sand blasting treatment to form minute uneven on one principal surface.

Specifically, sand blasting was performed by moving a nozzle at a predetermined scanning speed to scan the entire one principal surface of each of the glass members and spraying abrasive grains, made of alumina (Al₂O₃), as an abrasive from the nozzle using air at a predetermined treatment pressure.

Here, polygonal abrasive grains having an average particle diameter of 1.2 μm were used for the glass member of Sample 8, polygonal abrasive grains having an average particle diameter of 2.0 μm were used for the glass member of Sample 9, polygonal abrasive grains having an average particle diameter of 3.0 μm were used for the glass member of Sample 10, and polygonal abrasive grains having an average particle diameter of 4.0 μm were used for the glass member of Sample 11.

Note that the average particle diameter is a particle diameter of an abrasive material measured with a median diameter as D₅₀.

Further, the treatment pressure of the air in the nozzle was set to 0.40 MPa for the glass members of Samples 8 to 11.

Further, a distance (nozzle distance) between the glass member and a spray outlet of the nozzle was adjusted to be 4.0 mm for the glass members of Samples 8 to 11.

Furthermore, the scanning speed in movement of the nozzle was set to 15 mm/s for the glass members of Samples 8 to 11.

On the other hand, for a glass member of Sample 12 as Comparative Example, aluminosilicate glass (manufactured by Nippon Electric Glass Co., Ltd., product name: T2X-1) having a rectangular plate shape with a thickness of 0.5 mm was used, and no treatment was performed on one principal surface.

That is, the glass member of Sample 12 was untreated without using an abrasive.

Further, for a glass member of Sample 13 as Comparative Example, alkali-free glass (manufactured by Nippon Electric Glass Co., Ltd., product name: OA-10G) having a rectangular plate shape with a thickness of 0.5 mm was used, and a wet etching treatment (HF etching) with hydrofluoric acid was performed to form minute uneven on one principal surface.

Specifically, the one principal surface of the glass member was immersed in a hydrofluoric acid solution at a liquid temperature of 30° C., adjusted to a concentration of 5% by weight, and left for 2000 seconds to form the minute uneven.

Further, for a glass member of Sample 14 as Comparative Example, alkali-free glass (manufactured by Nippon Electric Glass Co., Ltd., product name: OA-10G) having a rectangular plate shape with a thickness of 0.5 mm was used, and silica coating was applied by a sol-gel method to form minute uneven on one principal surface.

Specifically, a liquid containing a silica component was applied by spraying, and the applied liquid containing the silica component was dried to form the minute uneven, formed of a silica coating film, on the principal surface.

Further, for a glass member of Sample 15 as Comparative Example, aluminosilicate glass (manufactured by Nippon Electric Glass Co., Ltd., product name: T2X-1) having a rectangular plate shape with a thickness of 0.5 mm was used, and a wet blasting treatment was performed to form minute uneven on one principal surface.

Specifically, the treatment was performed by using polygonal alumina abrasive grains having an average particle diameter of 6.9 μm and setting a concentration of a slurry to 1.0% by weight, a treatment pressure of air to 0.10 MPa, a distance between the glass member and an outlet of a nozzle to 20.0 mm, and a scanning speed in movement of the nozzle to 40 mm/s.

Conditions of the abrasives for the glass members of Samples 1 to 15 and conditions of the treatment pressure, the nozzle distance, and the scanning speed at the time of performing the wet blasting treatment or the sand blasting treatment as described above are described using Tables 1 and 2.

TABLE 1

| | | Method for | Particle diameter of | Concentration |
|---|---|---|---|---|
| | Sample | forming | abrasive material | of slurry |
| | No | uneven | D₅₀ [μm] | [Wt %] |
| Examples | 1 | Wet blasting | 1.2 | 6.0 |
| | 2 | | 1.2 | 6.0 |
| | 3 | | 1.2 | 6.0 |
| | 4 | | 3.0 | 6.0 |
| | 5 | | 3.0 | 6.0 |
| | 6 | | 6.9 | 6.0 |
| | 7 | | 6.9 | 6.0 |
| | 8 | Sand blasting | 1.2 | — |
| | 9 | | 2.0 | — |
| | 10 | | 3.0 | — |
| | 11 | | 4.0 | — |
| Comparative | 12 | Untreated | — | — |
| Examples | 13 | HF etching | — | — |
| | 14 | Silica coating | — | — |
| | 15 | Wet blasting | 6.9 | 1.0 |

TABLE 2

| | | Treatment | Nozzle | Scanning |
|---|---|---|---|---|
| | Sample | pressure | distance | speed |
| | No | [MPa] | [mm] | [mm/s] |
| Examples | 1 | 0.22 | 4.0 | 1 |
| | 2 | 0.22 | 4.0 | 40 |
| | 3 | 0.13 | 4.0 | 40 |
| | 4 | 0.15 | 4.0 | 20 |
| | 5 | 0.25 | 4.0 | 10 |
| | 6 | 0.15 | 4.0 | 20 |
| | 7 | 0.25 | 4.0 | 10 |
| | 8 | 0.40 | 4.0 | 15 |
| | 9 | 0.40 | 4.0 | 15 |
| | 10 | 0.40 | 4.0 | 15 |
| | 11 | 0.40 | 4.0 | 15 |
| Comparative | 12 | — | — | — |
| Examples | 13 | — | — | — |
| | 14 | — | — | — |
| | 15 | 0.10 | 20.0 | 40 |

### [Measurement of Surface Roughness]

Next, a surface roughness of the principal surface was measured for the glass members of Samples 1 to 15.

The surface roughness was measured on the principal surface subjected to the wet blasting treatment for Samples 1 to 7 and 15, on the principal surface subjected to the sand blasting treatment for Samples 8 to 11, on one principal surface for Sample 12, on the principal surface subjected to the wet etching treatment with hydrofluoric acid for Sample 13, and on the principal surface provided with the silica coating film for Sample 14.

As parameters of the measured surface roughness, the arithmetical mean height Sa, the void volume Vvv of reduced valleys, and the material volume Vmp of reduced peaks of the formed minute uneven were measured using an atomic force microscope (AFM).

Further, the ratio (Vvv/Vmp) of the void volume Vvv of reduced valleys to the material volume Vmp of reduced peaks was derived based on the above-described measured values.

Here, the areal material ratio curve T of an area was obtained by dividing an interval (that is, an interval between the uppermost end portion 10a1 of the projections (peaks) and the lowermost end portion 10a2 of the recesses (valleys) in FIG. 2 as described above) from a maximum peak height to a maximum valley depth equally into 512 intervals, and plotting an areal material ratio at each height.

Further, the regression line L obtained through the least square method, the coefficient of determination R², the root mean square error d, and the maximum height h within a range in the areal material ratio from 1% to 99% were derived from the areal material ratio curve T of the area based on the above plot.

Note that the atomic force microscope (AFM) used for the measurement was Dimension Icon (SPM unit) and Nano Scope V (Controller unit), atomic force microscopes manufactured by Bruker Corporation, and the measurement was performed on the basis of ISO 25178.

Further, as measurement conditions, a tapping mode was used, and the measurement was performed on a region having a measurement area of 5×5 μm at a scan rate of 1 Hz to acquire the number of pieces of data of 512×512.

### [Measurement of Haze]

Next, a haze was measured for the glass members of Sample 1 to 14.

The haze was measured on the basis of JISK7361-1:1997 using an ultraviolet-visible near-infrared spectrophotometer (UV-3100PC) manufactured by Shimadzu Corporation.

### [Evaluation of Feel of Writing]

Next, in order to confirm the feel of writing for the glass members of Samples 1 to 15, evaluation was performed by the following method.

As an evaluation method, first, two types of pens including a pen X formed of Pro Pen (product name “KP-503E”) manufactured by Wacom Co., Ltd. equipped with a refill (product name “ACK-20004: elastomer nib”) manufactured by Wacom Co., Ltd., and a pen Y formed of Apple Pencil 2 manufactured by Apple Inc. were prepared, and each of the pen X and the pen Y was used to write Japanese Hiragana character “A” on the principal surface on which the minute uneven were formed, and a comparison with the feel of writing between paper and a ballpoint pen was performed, and an evaluation was made as “O” in a case where the feel of writing was good, and as “x” in a case where the feel of writing was poor.

### [Evaluation of Feel of Touching]

Next, in order to confirm the feel of touching with a fingertip for the glass members of Samples 1 to 15, evaluation was performed by the following method.

As an evaluation method, the principal surface on which the minute uneven were formed was swiped several times with the fingertip, and an evaluation was made as “O” in a case where the principal surface felt appropriately slippery, as “A” in a case where the principal surface felt slightly slippery, and as “x” in a case where the principal surface felt the feel of being caught on the fingertip.

Measurement results of the surface roughness and the haze, and evaluation results of the feel of writing and the feel of touching regarding the glass member of Samples 1 to 15 described above are described using Tables 3 and 4.

TABLE 3

| | Sample | Sa | Vvv | Vmp | Vvv/ | | d | h | |
|---|---|---|---|---|---|---|---|---|---|
| | No | [nm] | [nm³] | [nm³] | Vmp | R² | [nm] | [nm] | d/h |
| Examples | 1 | 12.1 | 1.88 | 0.58 | 3.24 | 0.939 | 4.460 | 70.7 | 0.063 |
| | 2 | 12.5 | 2.17 | 0.82 | 2.65 | 0.902 | 5.850 | 83.5 | 0.070 |
| | 3 | 3.4 | 1.00 | 0.37 | 2.70 | 0.693 | 4.120 | 34.2 | 0.121 |
| | 4 | 12.9 | 2.68 | 0.81 | 3.30 | 0.850 | 8.040 | 89.9 | 0.089 |
| | 5 | 21.9 | 4.46 | 1.04 | 4.29 | 0.854 | 13.770 | 144.3 | 0.095 |
| | 6 | 26.3 | 6.68 | 1.67 | 4.00 | 0.749 | 25.230 | 212.9 | 0.119 |
| | 7 | 42.3 | 7.73 | 1.31 | 5.90 | 0.899 | 19.420 | 241.4 | 0.080 |
| | 8 | 7.7 | 3.44 | 0.23 | 14.70 | 0.683 | 9.090 | 63.1 | 0.144 |
| | 9 | 8.3 | 2.77 | 0.66 | 4.20 | 0.760 | 9.400 | 85.1 | 0.110 |
| | 10 | 13.7 | 4.09 | 0.49 | 8.35 | 0.821 | 12.800 | 114.5 | 0.112 |
| | 11 | 28.7 | 5.29 | 1.95 | 2.71 | 0.830 | 17.710 | 210.9 | 0.084 |
| Comparative | 12 | 0.2 | 0.023 | 0.010 | 2.30 | 0.963 | 0.044 | 1.0 | 0.042 |
| Examples | 13 | 3.6 | 0.49 | 0.23 | 2.13 | 0.965 | 0.910 | 21.5 | 0.042 |
| | 14 | 10.6 | 0.90 | 1.03 | 0.87 | 0.976 | 2.380 | 63.4 | 0.038 |
| | 15 | 2.2 | 1.28 | 0.08 | 16.00 | 0.521 | 3.950 | 23.7 | 0.166 |

TABLE 4

| | Sample | Haze | Feel of writing | Feel of writing | Feel of |
|---|---|---|---|---|---|
| | No | [%] | (Pen X) | (Pen Y) | touching |
| Examples | 1 | 1.4 | ○ | ○ | ○ |
| | 2 | 0.8 | ○ | ○ | ○ |
| | 3 | 0.2 | ○ | ○ | Δ |
| | 4 | 1.1 | ○ | ○ | ○ |
| | 5 | 3.4 | ○ | ○ | ○ |
| | 6 | 4.0 | ○ | ○ | ○ |
| | 7 | 19.5 | ○ | ○ | ○ |
| | 8 | 2.9 | ○ | ○ | ○ |
| | 9 | 2.8 | ○ | ○ | ○ |
| | 10 | 2.9 | ○ | ○ | ○ |
| | 11 | 3.2 | ○ | ○ | ○ |
| Comparative | 12 | 0.1 | x | x | x |
| Examples | 13 | 0.2 | x | x | x |
| | 14 | 11.2 | x | x | ○ |
| | 15 | 0.2 | x | x | x |

### [Consideration]

First, as shown in Table 4, in the glass members of Samples 1 to 11 as Examples, the feel of writing on the principal surface on which the minute uneven were formed was “O” regardless of whether the pen X or the pen Y was used, and results were good.

Further, in the glass members of Samples 1, 2, and 4 to 11 as Examples and the glass member of Sample 3 as Example, the feel of touching with the fingertip was “O” and “Δ”, respectively, and results were substantially good in all the cases.

On the other hand, in the glass members of Samples 12 to 15 as Comparative Examples, the feel of writing on the principal surface on which the minute uneven were formed was “X” regardless of whether the pen X or the pen Y was used, and results were poor.

Further, in the glass members of Samples 12, 13, and 15 as Comparative Examples, the feel of touching with the fingertip was also “X”, and results were poor.

Note that, in the glass member of Sample 14 in which silica coating was applied to one principal surface, the feel of touching with the fingertip was “O”, and a result was good.

Based on these results, the measurement results of the surface roughness regarding the glass members of Samples 1 to 15 will be considered.

As shown in Table 3, the coefficient of determination R² of the regression line L obtained by performing the simple regression analysis through the least square method upon the range in the areal material ratio from 10% to 99% of the areal material ratio curve T of the area was a value within a range of 0.683 to 0.939 in the glass members of Samples 1 to 11 as Examples.

On the other hand, in Comparative Examples, the coefficient of determination R² of the regression line L was a value within a range of 0.963 to 0.976 in the glass members of the untreated Sample 12, Sample 13 subjected to the wet etching treatment with hydrofluoric acid, and Sample 14 subjected to silica coating, and the coefficient of determination R² of the regression line L was 0.521 in the glass member of Sample 15 subjected to wet blasting.

Further, the ratio (d/h) of the root mean square error d of the regression line L, obtained by performing the simple regression analysis through the least square method upon the range in the areal material ratio from 10% to 99% of the areal material ratio curve T of the area, to the maximum height h in the range in the areal material ratio from 1% to 99% was a value within a range of 0.063 to 0.144 in the glass members of Samples 1 to 11 as Examples.

On the other hand, in Comparative Examples, the ratio (d/h) was within a range of 0.038 to 0.042 in the glass members of the untreated Sample 12, Sample 13 subjected to the wet etching treatment with hydrofluoric acid, and Sample 14 subjected to silica coating, and the ratio (d/h) was 0.166 in the glass member of Sample 15 subjected to wet blasting.

Furthermore, the proportion (Vvv/Vmp) of the material volume Vmp of reduced peaks to the void volume Vvv of reduced valleys when an areal material ratio indicating a boundary between a core surface and the reduced valleys was 10% and an areal material ratio indicating a boundary between the core surface and the reduced valleys was 80% in the areal material ratio curve T of the area was a value within a range of 2.65 to 14.70 in the glass members of Samples 1 to 11 as Examples.

On the other hand, in Comparative Examples, the ratio (Vvv/Vmp) was a value within a range of 0.87 to 2.30 in the glass members of the untreated Sample 12, Sample 13 subjected to the wet etching treatment with hydrofluoric acid, and Sample 14 subjected to silica coating, and the ratio (Vvv/Vmp) was 16.00 in the glass member of Sample 15 subjected to wet blasting.

As apparent from the above results, when an uneven shape of the minute uneven satisfies at least any one of the above-described predetermined conditions, that is, the coefficient of determination R² of the regression line L being a numerical value within the range of 0.600 to 0.960, the ratio (d/h) being a numerical value within the range of 0.045 to 0.165, and the ratio (Vvv/Vmp) being a numerical value within the range of 2.4 to 15, a glass member having the minute uneven exhibits excellent performance in terms of the feel of writing and the feel of touching.

Although the embodiments of the present application have been described above, these embodiments do not limit the present application in any way, but are merely illustrative. It is a matter of course that the present application can be implemented in various other forms within a scope not departing from the gist thereof, and the scope of the present application is indicated by the description of the claims, and further encompasses meanings equivalent to the description of the claims and all changes within the scope.

### REFERENCE SIGNS LIST

1 Pen input device
2 Input device
3 Input pen
10 Minute uneven
21 Glass substrate (glass member)
21a Principal surface (surface)
22 Display element (display device)
23 Digitizer circuit (detection circuit)
100 Mobile apparatus
101 Back cover member
L Regression line
T Areal material ratio curve of area

1. A glass member comprising
minute uneven on at least a portion of a surface,
wherein a coefficient of determination R² of a regression line is 0.600 to 0.960, the regression line being obtained by performing simple regression analysis through a least square method upon a range in load area percentage from 10% to 99% of an areal material ratio curve of an area within a square region of the minute uneven, one side of the square region measuring 5 μm.

2. A glass member comprising
minute uneven at least a portion of a surface,
wherein, in an areal material ratio curve of an area within a square region of the minute uneven, one side of the square region measuring 5 μm,
a ratio (d/h) of a root mean square error d between the areal material ratio curve and a regression line to a maximum height h (=ha−hb) is 0.045 to 0.165, the regression line being obtained by performing simple regression analysis through a least square method upon a range in load area percentage from 10% to 99%, and
the maximum height h being a difference between a height ha at the areal material ratio of 1% and a height hb at the load area percentage of 99%.

3. A glass member comprising
minute uneven on at least a portion of a surface,
wherein, in an areal material ratio curve of an area within a square region of the minute uneven, one side of the square region measuring 5 μm,
a ratio (Vvv/Vmp) of a void volume Vvv of reduced valleys to a material volume Vmp of reduced peaks is 2.4 to 15 when a load area percentage indicating a boundary between a core surface and the reduced valleys in the minute uneven is 10% and an areal material ratio indicating a boundary between the core surface and the reduced peaks in the minute uneven is 80%.

4. The glass member according to claim 1, wherein
in the minute uneven,
an arithmetical mean height Sa of roughness profile elements is 1 nm to 100 nm.

5. An input device comprising:
a glass substrate made of the glass member according to claim 1;
a display device that displays an image; and
a detection circuit that detects an input position.

6. A pen input device comprising:
the input device according to claim 5; and
an input pen that performs an input operation on the input device by being moved in contact with a surface of the glass substrate.

7. A mobile apparatus comprising
a back cover member including the glass member according to claim 1.

8. A method for manufacturing the glass member according to claim 1, comprising
performing a wet blasting treatment or a sand blasting treatment on the surface of the glass member.

9. The glass member according to claim 2, wherein
in the minute uneven,
an arithmetical mean height Sa of roughness profile elements is 1 nm to 100 nm.

10. The glass member according to claim 3, wherein
in the minute uneven,
an arithmetical mean height Sa of roughness profile elements is 1 nm to 100 nm.

11. An input device comprising:
a glass substrate made of the glass member according to claim 2;
a display device that displays an image; and
a detection circuit that detects an input position.

12. An input device comprising
a glass substrate made of the glass member according to claim 3;
a display device that displays an image; and
a detection circuit that detects an input position.

13. An input device comprising:
a glass substrate made of the glass member according to claim 4;
a display device that displays an image; and
a detection circuit that detects an input position.

14. A pen input device comprising:
the input device according to claim 11; and
an input pen that performs an input operation on the input device by being moved in contact with a surface of the glass substrate.

15. A pen input device comprising:
the input device according to claim 12; and
an input pen that performs an input operation on the input device by being moved in contact with a surface of the glass substrate.

16. A pen input device comprising:
the input device according to claim 13; and
an input pen that performs an input operation on the input device by being moved in contact with a surface of the glass substrate.

17. A mobile apparatus comprising
a back cover member including the glass member according to claim 2.

18. A mobile apparatus comprising
a back cover member including the glass member according to claim 3.

19. A mobile apparatus comprising
a back cover member including the glass member according to claim 4.
